(19) United States
(12) Patent Application Publication
(10) Pub. No.: US 2026/0175486 A1
(43) Pub. Date: Jun. 25, 2026

(54) TOOLING AND METHODS FOR FORMING A COMPONENT WITH AN OVERMOLD LAYER

(71) Applicant: Magna Exteriors Inc., Aurora (CA)

(72) Inventors: Heiner Salzmann, Metamora, MI (US); Riad Chaaya, Clarkston, MI (US); Stanislav Tichy, Troy, MI (US); Peter V. MacLean, Clinton Township, MI (US); Mark Hess, Gaines, MI (US); Parvinder S. Walia, Shelby Township, MI (US); Marek Blascik, Southfield, MI (US); Michael Pailey, Essex (CA); Miguel Benitez, Troy, MI (US)

(21) Appl. No.: 19/421,623

(22) Filed: Dec. 16, 2025

Related U.S. Application Data
(60) Provisional application No. 63/738,352, filed on Dec. 23, 2024.

(51) Int. Cl. B29C 45/14; B29C 33/00

(52) U.S. Cl. CPC B29C 45/14418; B29C 33/0044; B29C 45/14196

(57) ABSTRACT

A method for forming an overmolded component, includes arranging a first mold part and a second part with at least part of a first mold cavity defined by the first mold part and the second mold part, providing material to form a substrate into the first mold cavity, providing an overmold cavity that is defined at least in part by the substrate, one or both of the first mold part and second mold part, and a seal that engages the substrate and also engages one or both of the first mold part and the second mold part, and providing material for an overmolded layer in the overmold cavity. The overmold layer may be formed from a material having low viscosity and the seal inhibits or prevents overflow of the overmold material to reduce or eliminate formation of flash at parting or junction lines in the molding process.

### REFERENCE TO RELATED APPLICATIONS

This application claims the benefit of U.S. Provisional Application Ser. No. 63/738,352 filed on Dec. 23, 2024 the content of which is incorporated herein by reference in its entirety.

### FIELD

The present invention relates to a component with an integrated seal and methods of making the component with the integrated seal.

### BACKGROUND

Some components, like automotive doors, liftgates, tailgates and the like, include perimeter seals or gaskets that reduce intrusion of noise, wind and contaminants into the vehicle. Some trim panels have seals molded onto part of the panels. Low viscosity materials used to form the seals, like polyurethane, are difficult to mold without overflow within mold tooling, which results in flash that must then be trimmed off. Trimming the material can affect the part surface finish, appearance and durability, and the trimming operation requires extra time and cost to form a part, and more material is needed to form the seal with the flash.

### SUMMARY

A method for forming an overmolded component, includes arranging a first mold part and a second part with at least part of a first mold cavity defined by the first mold part and the second mold part, providing material to form a substrate into the first mold cavity, providing an overmold cavity that is defined at least in part by the substrate, one or both of the first mold part and second mold part, and a seal that engages the substrate and also engages one or both of the first mold part and the second mold part, and providing material for an overmolded layer in the overmold cavity. The overmold layer may be formed from a material having low viscosity and the seal inhibits or prevents overflow of the overmold material to reduce or eliminate formation of flash at parting or junction lines in the molding process.

In at least some implementations, the seal is carried by the first mold part and engages the second mold part and the substrate. In at least some implementations, the overmold cavity is defined by the substrate, the second mold part and the seal. In at least some implementations, the first mold part includes a cavity and the seal is located in the cavity.

In at least some implementations, the method also includes providing a third mold part to define part of the overmold cavity, and wherein the seal is attached to the third mold part. In at least some implementations, the seal carried by the third mold part is compressed during formation of the overmolded layer and the seal engages the second mold part and the substrate. In at least some implementations, the seal carried by the third mold part engages the first mold part, the second mold part and the substrate. In at least some implementations, a portion of the third mold part spaced from the seal defines part of the first mold cavity such that the seal does not define part of the first mold cavity, and the method includes moving the third mold part from a first position in which the third mold part defines part of the first mold cavity to a second position in which the seal defines part of the overmold cavity.

In at least some implementations, the seal is compressed during formation of the overmolded layer.

In at least some implementations, the method also includes providing a third mold part and wherein the seal is attached to the third mold part, and the seal defines part of the first mold cavity. In at least some implementations, the third mold part is movable from a first position in which the seal defines part of the first mold cavity to a second position in which the seal defines part of the overmold cavity.

In at least some implementations, the method also includes providing a third mold part and a fourth mold part, wherein the method includes locating the third mold part so that the third mold part defines part of the first mold cavity, and after the material for the substrate is provided into the first mold cavity, moving the third mold part and providing a fourth mold part that includes the seal to define part of the overmold cavity.

In at least some implementations, a method of forming an overmolded component includes defining a first mold cavity, a seal mold cavity and an overmold cavity. The method includes:
arranging a first mold part, a second part and a third mold part to define at least part of a first mold cavity;
providing material to form a substrate into the first mold cavity;
arranging the first mold part, the second mold part and the third mold part to define a seal mold cavity, where the seal cavity is defined in part by the substrate;
providing material for a seal in the seal mold cavity;
providing an overmold cavity that is defined at least in part by the seal and the substrate; and
providing material for an overmolded layer in the overmold cavity.

In at least some implementations, the overmold cavity is partly defined by a fourth mold part that is different than the first mold part, the second mold part, and the third mold part. In at least some implementations, the seal is compressed by the fourth mold part to close off part of the overmold cavity.

In at least some implementations, the third mold part is movable relative to the first mold part and the second mold part from a first position in which the third mold part defines part of the first mold cavity to a second position in which the third mold part defines part of the seal mold cavity.

In at least some implementations, the seal mold cavity is defined by the first mold part, the second mold part, the third mold part and the substrate.

In at least some implementations, the first mold part defines a portion of the first mold cavity that defines at least part of an inner surface of the substrate, the second mold part defines a portion of the first mold cavity that defines at least part of an outer surface of the substrate, and the third mold part defines part of the first mold cavity that defines at least part of a peripheral edge of the substrate between the inner surface and the outer surface.

In at least some implementations, the seal mold cavity is defined in part by the peripheral edge of the substrate.

In at least some implementations, the seal is compressed by one or more of the first mold part, the second mold part and the third mold part to close off part of the overmold cavity.

### BRIEF DESCRIPTION OF THE DRAWINGS

FIG. 1 is a sectional view of part of a mold system for forming a substrate with an overmolded layer, with the substrate shown in a first mold cavity;

FIG. 2 is a view similar to FIG. 1 and showing the overmolded layer formed in an overmold cavity;

FIG. 3 is a sectional view of part of a mold system showing a substrate in a first mold cavity;

FIG. 4 is a view similar to FIG. 3 and showing the overmolded layer formed in an overmold cavity;

FIG. 5 is a view similar to FIG. 4 showing an extended overmolded layer;

FIGS. 6 and 7 are sectional views of part of a mold system showing formation of a substrate in a first mold cavity and of an overmolded layer in an overmold cavity;

FIGS. 8 and 9 are sectional views of part of a mold system showing formation of a substrate in a first mold cavity and of an overmolded layer in an overmold cavity;

FIG. 10 is a view similar to FIG. 9 showing an extended overmolded layer;

FIG. 11 is a view similar to FIG. 10 showing an extended overmolded layer and overflow seal;

FIGS. 12 and 13 are sectional views of part of a mold system showing formation of a substrate in a first mold cavity and of an overmolded layer in an overmold cavity;

FIGS. 14-17 are sectional views of part of a mold system showing formation of a substrate in a first mold cavity and of an overmolded layer in an overmold cavity;

FIG. 18 is a view showing a modified overflow seal and substrate formed thereby;

FIGS. 19-21 are sectional views of part of a mold system showing formation of a substrate in a first mold cavity, an overmolded layer in an overmold cavity and a seal in a third mold cavity;

FIGS. 22-24 are sectional views of part of a mold system showing formation of a substrate in a first mold cavity, an overmolded layer in an overmold cavity and a seal in a third mold cavity;

FIGS. 25-27 are sectional views similar to FIG. 24 and showing modified seals;

FIG. 2. 28-31 are sectional views of part of a mold system showing formation of a substrate in a first mold cavity, an overmolded layer in an overmold cavity and a seal in a third mold cavity;

FIGS. 32-34 are sectional views of part of a mold system showing formation of a substrate in a first mold cavity, of an overmolded layer in an overmold cavity and a seal in a third mold cavity;

FIGS. 35-38 are sectional views showing alternate substrate, overmolded layers and/or seals that can be formed by corresponding mold tools in a mold system; and

FIGS. 39-41 are sectional views showing formed components in an assembly adjacent to a surface of a different component.

### DETAILED DESCRIPTION

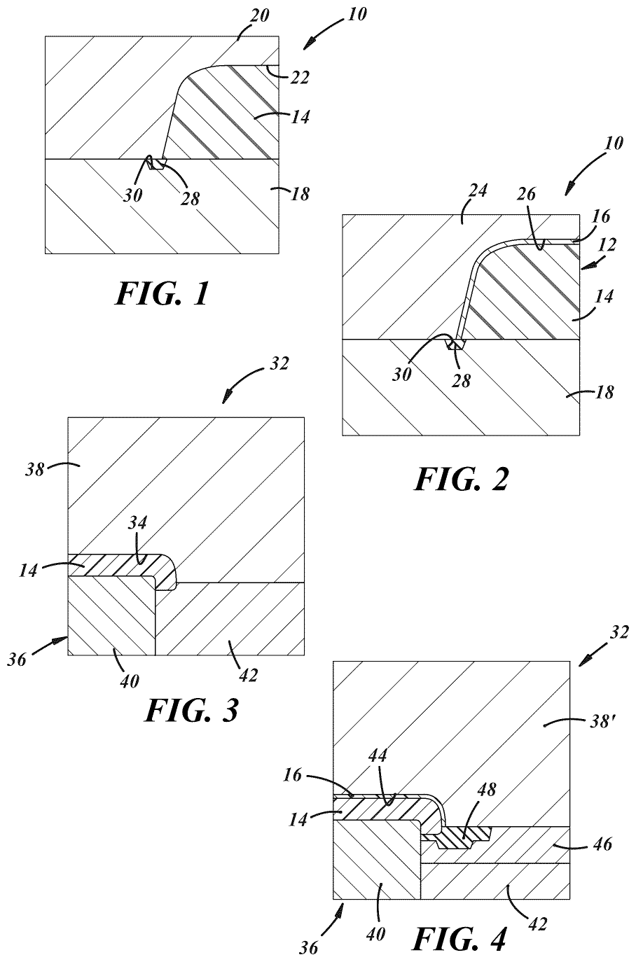

Referring in more detail to the drawings, FIGS. 1 and 2 show a mold system 10 in which a vehicle component 12 is molded. As shown in FIG. 2, the vehicle component 12 includes a substrate 14 formed of a first material and an overmolded layer 16 molded onto the substrate 14 and formed of a second material. The vehicle component 12 may have various end uses, and the overmolded layer 16 may be provided on all or part of the substrate 14, as desired. In at least some implementations, the overmolded layer 16 is formed from a low-viscosity material, such as polyurethane, and is molded onto the substrate 14 in a multi-shot injection molding process.

As shown in FIG. 1, the mold system includes a first mold part 18 and a second mold part 20 arranged to define a first mold cavity 22 defined between the mold parts 18, 20. To form the substrate 14, material for the substrate is provided in the mold cavity 22 and allowed to at least partially cure. Thereafter, the second mold part 20 is moved away from the first mold part 18 and a third mold part 24 (FIG. 2) is arranged relative to the first mold part 18 to define, with a portion of the substrate 14, an overmold cavity 26. Material for the overmolded layer 16 is injected into the overmold cavity 26 so that the overmolded layer is formed directly on the substrate 14. The third mold part 24 may be entirely different from the second mold part 20, or the second mold part 18 may include a movable or removable portion that, when removed or moved from the position used to define the mold cavity 22, enables the transformed mold part to define the overmold cavity 26. In this regard, the new or moved or changed mold part may be called a modified second mold part, in some implementations and examples. In some implementations, the overmold cavity 26 may be defined by simply moving the second mold part 20 away from the first mold part 18 to define an open area between the formed substrate 14 and at least part of a mold surface of the second mold part 20. Also or instead, the first mold part 18 may have movable or removable sections that can define all or part of the overmold cavity 26.

To limit or prevent overflow of the material for the overmolded layer 16 when that material is injected into the mold cavity 26, the mold system 10 is set up with a seal, sometimes called herein an overflow seal 28, on one or more of the mold parts used to form the substrate 14 and overmolded layer 16. The overflow seal 28 may be implemented in various ways, as shown in the drawings and described herein below.

In the embodiment shown in FIGS. 1 and 2, an example of an overflow seal 28 is embedded or attached to the first mold part 18. The overflow seal 28 is located so that the overflow seal 28 defines part of at least the overmold cavity 26, and is overlapped by part of the third mold part during molding of the overmolded layer 16 (or the second mold part in implementations where the same mold part is moved and used to define part of the overmold cavity). To reduce or eliminate flow of the material of the overmolded layer 16 between the substrate 14 and the first mold part 18, the overflow seal 28 may also define part of the first mold cavity 22 and may be overlapped by and abut the substrate 14. The overflow seal 28, in at least some implementations, may be molded onto the first mold part 18, such as within an overflow seal cavity 30 defined in the first mold part 18.

The overflow seal 28 is a single part, continuous body and may be formed of or include a material that is compressible and that does not bond with the material of the substrate 14 or the overmolded layer 16 during the molding process and while the just molded vehicle component remains in the mold. In some implementations, the overflow seal 28 may include an insert, such as a metal stiffener or other more rigid support member, for providing support and increased structural integrity for the overflow seal 28. At least the portion of the overflow seal 28 that defines part of the overmold cavity 26 may be compressible to provide improved sealing between the mold parts used to define the overmold cavity 26, and also between the substrate 14 and the first mold part 16. As the overflow seal 28 is present during molding of both the substrate 14 and overmolded layer 16, the material of the overflow seal 28 is selected to withstand the temperatures and pressures that exist during the molding process. The material of the overflow seal 28 may also be selected to not bond with and to release cleanly from the substrate 14 and overmolded layer 16 after the molding process. In at least some implementations, the overflow seal 28 includes or is defined by a silicone material, or a PTFE seal or coated seal or the like, with or without release agents, may be used.

FIG. 3 shows a similar molding system 32 for the vehicle component 12. In this system, a first mold cavity 34 in which the substrate 14 is formed is defined by a first mold part 36 and a second mold part 38. The first mold part 36 has a core 40 and a movable part 42 that moves relative to the core 40 that is called a core slider. In the molding process using this mold system 32, the core slider 42 is in a first position in which the core slider 42 abuts both the core 40 and the second mold part 38, and the material for the substrate 14 is provided into the first mold cavity 34.

Thereafter, to provide the overmolded layer 16 on the component 12, the second mold part 38 is modified/moved or replaced by a different mold part 38′ (e.g. the second mold part is moved relative to the substrate and first mold part 36 or a different mold part is substituted for the second mold part, or a movable portion of the second mold part is moved) to define part of the overmold cavity 44 in which the overmolded layer 16 will be formed. Additionally, the core slider 42 is moved away and a third mold part 46 is inserted into and takes up some of the space resulting from movement of the core slider 42.

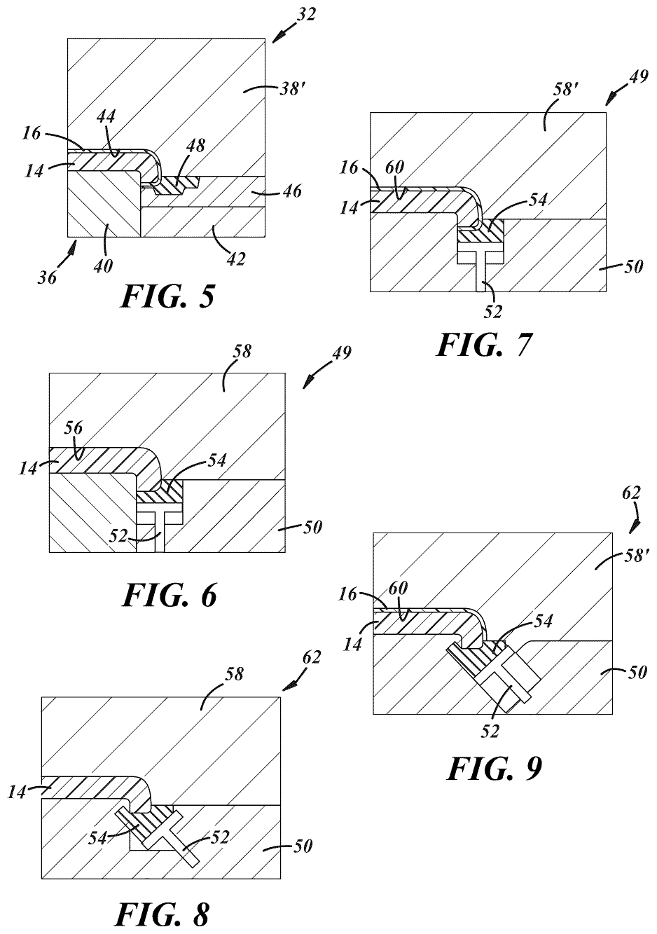

As shown in FIG. 4, the third mold part 46 includes an overflow seal 48 attached thereto (e.g. molded into a cavity of the third mold part). The overflow seal 48 is arranged to define part of the overmold cavity 44 and to abut portions of the substrate 14 and the second mold part 38 that also define part of the overmold cavity 44. The overflow seal 48 may be formed and may function as described above with regard to the overflow seal 28, to limit overflow and formation of flash during molding of the material for the overmolded layer 16 onto the substrate 14. FIG. 5 illustrates a component formed with the overmolded layer 16 extending around an additional surface of the substrate 14 (shown as an end or edge), enabled by a suitable shaped overflow seal and corresponding mold parts. In this example, the core 40 also defines part of the overmold cavity 44 and the overflow seal 48 also abuts the core 40 to reduce or prevent overflow of material out of the overmold cavity 44 and flash formation at the interface between the overmolded layer 16 and the core 40.

In the example shown in FIGS. 6 and 7, a mold system 49 includes a first mold part 50 that has or is adjacent to a movable portion 52 on which an overflow seal 54 is carried. The first mold cavity 56, shown in FIG. 6, is defined between the first mold part 50, the second mold part 58 and the overflow seal 54. The overflow seal 54 engages portions of both the first and second mold parts 50, 58 to enclose that area of the first mold cavity 56 during molding of the substrate 14. Thereafter, the second mold part 58 may be modified (and is labeled as 58′ in FIG. 7) to define part of the overmold cavity 60 which also is defined by the substrate 14 and the overflow seal 54. During this stage of the molding process, the overflow seal 54 engages the first mold part 50, second mold part 58′ and the substrate 14 to enclose that area of the overmold cavity 60 during molding of the overmolded layer 16 onto the substrate 14. If desired, and as shown in FIG. 7, the movable mold part 52 may be moved away from the substrate 14 to enable material of the overmolded layer 16 to flow around the adjacent surface of the substrate 14, in which case part of the overmold cavity 60 may also be defined by the first mold part 50, and suitable sealing can be provided between the overflow seal 54 and the first mold part 50.

The mold system 62 shown in FIGS. 8 and 9 is similar to that shown in FIGS. 6 and 7. In this example, the movable mold part 52 is oriented at and movable along a non-zero angle to the direction of movement of the second mold part 58 relative to the first mold part 50. The overflow seal 54 is slidable engaged with the first mold part 50 and compressed against the second mold part 58 to define part of the first mold cavity 56 for forming the substrate 14, and the overmold cavity 60 for molding the overmolded layer 16 onto the substrate 14. To define the overmold cavity 60, the second mold part 58′ is modified and the portion of the overflow seal 54 abutting the second mold part 58′ may be partially decompressed compared to its state when the substrate 14 is formed, but still maintains contact with the substrate 14 and the second mold part 58′ and provides a sealing force between them to inhibit or prevent flow of the material for the overmolded layer 16 along those junctures or interfaces.

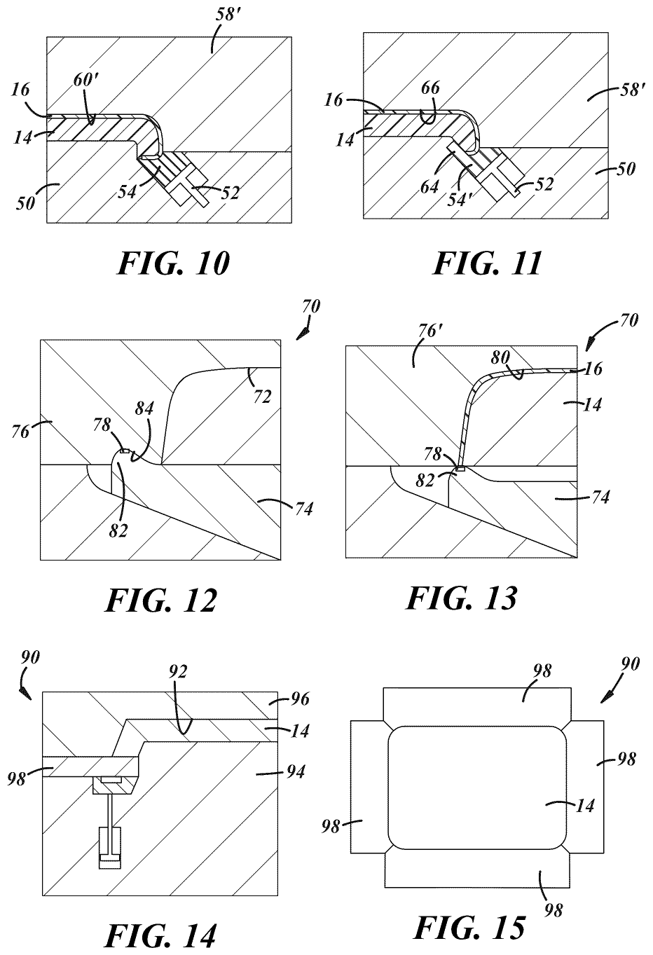

In the example shown in FIG. 10, to form the overmold cavity 60′, the second mold part 58 is modified, and the movable mold part 52 is moved away from the substrate 14 so that part of the overmold cavity 60′ is defined between the overflow seal 54 and the adjacent portion of the substrate 14. During this movement, the overflow seal 54 partially decompresses but maintains contact with the second mold part 58′ and the first mold part 50, and a sealing force between them, to inhibit or prevent overflow of the material for the overmolded layer 16′.

A similar example is shown in FIG. 11, with the movable mold part 52 having been moved from a first position used in forming the substrate 14 to a second position used in forming the overmolded layer 16. In this example, the overflow seal 54′ includes an elongated interface portion 64 about which part of the substrate 14 is formed. During movement of the movable mold part 52, the interface portion 64 slides along a surface of the substrate 14 but maintains a seal therewith in the second position of the movable mold part 52. Thus, the overmold cavity 66 is defined between the substrate 14, the overflow seal 54′ and the first mold part 50, and is sealed off by engagement of one portion of the overflow seal 54′ that abuts the first mold part 50 and a second portion of the overflow seal 54′ in the interface portion 64 that engages the substrate 14.

In the implementation of a mold system 70 shown in FIGS. 12 and 13, the first mold cavity 72, shown in FIG. 12, is defined between a first mold part 74 and a second mold part 76. An overflow seal 78 is carried by the first mold part 74 at a location spaced from the portion of the first mold part 74 that defines part of the first mold cavity 72. To define the overmold cavity 80, as shown in FIG. 13, a different or modified second mold part 76′ may be provided to provide space between it and part of the substrate 14, and the first mold part 74 is moved so that the overflow seal 78 abuts the second mold part 76′ and the substrate 14. In the example shown, the first mold part 74 has a concave surface, and a raised outer portion 82 including the overflow seal 78 is received in a pocket or cavity 84 in the second mold part 76 that is used to define the first mold cavity 72, as shown in FIG. 12. Other shapes and orientations of the mold parts may be used that employ the concept of the overflow seal as shown in FIGS. 12 and 13.

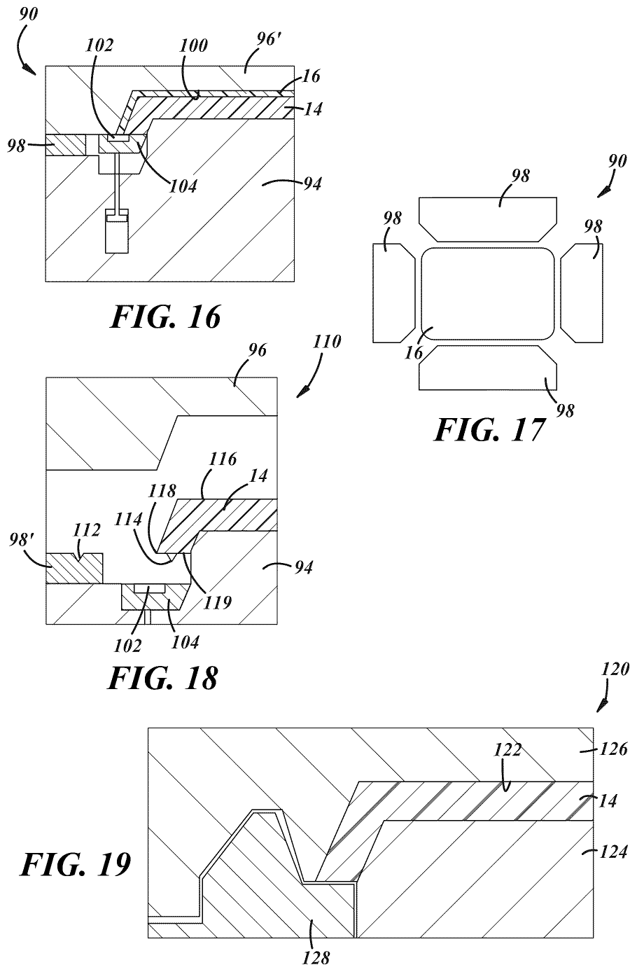

Referring now to FIGS. 14-17, a mold system 90 is shown in which the first mold cavity 92 for the substrate 14, as shown in FIG. 14, is defined by a first mold part 94, a second mold part 96 and a third mold part 98 or slider. FIG. 15 shows a top view in which it can be seen that multiple third mold parts/sliders 98 may surround the entire periphery of the substrate 14 being formed. FIG. 16 shows the overmold cavity 100 which is defined by the second or a modified second mold part 96′, the substrate 14, and an overflow seal 102 carried by a fourth mold part 104 which may be a slider or lifter. In this system, the third mold parts 98 are moved out of the way and do not form part of the overmold cavity 100. The overflow seal 102 is carried by different mold parts 104 that do not form part of the first mold cavity 92. The third mold parts 98 move laterally, perpendicular to the direction of travel of the second mold part 96 relative to the first mold part 94, and the fourth mold part(s) 104 moves vertically, in/parallel to the direction of travel of the second mold part, but the reverse could be true or other angles/directions of movement may be used to achieve the desired positioning of these mold parts. During molding of the overmolded layer 16 to the substrate 14, the overflow seal 102 abuts and seals against the substrate 14 and the second mold part 96—in this example, the first mold part 94 does not define part of the overmold cavity 100. FIG. 17 shows the molded component 12 with the substrate 14 and overmolded layer 16.

The example mold system 110 shown in FIG. 18 is similar to the mold system 90 of FIGS. 14-17, but in this system 110, the third mold part 98′ that defines part of the first mold cavity 92′ includes a void 112 in a portion that defines the first mold cavity 92′. This void 112 is filled by material of the substrate 14 and provides a depending or outwardly extending projection 114 (e.g. rib or flange) on that portion of the substrate 14. The projection 114 may be arranged around the periphery of the substrate 14, spaced from an outer surface 116 of the substrate 14, that is, offset from a corner 118 of the substrate, such that the overmolded layer 16 is formed over the corner 118 and on part of a peripheral edge 119 of the substrate, and a boundary of the overmold cavity 100′ is defined by the projection 114. The projection 114 may also provide increased compression of the overflow seal 102 or improved contact over a relatively small surface area and an improved seal may be formed between them, to inhibit of prevent material of the overmolded layer 16 from flowing between the projection 114 and overflow seal 102.

In the above-described implementations, the overflow seals were carried by a mold part and used to seal part of an overmold cavity in which an overmolded layer 16 was formed onto a substrate 14. In the implementations described hereafter, the overflow seal is molded onto the substrate and thereafter, the overmolded layer 16 is molded onto one or both of the substrate 16 and the overflow seal. As the overflow seal can be formed of different materials than the overmolded layer 16, and of different size, shape and location, the combined parts can provide a range of functions and benefits to a finished component and vehicle in which the component is installed. For example, the seal can be formed of silicone or other elastomeric material(s) that is compressible for forming a seal in use of the substrate, and is also compressible and used to form a seal against overflow of the material used in forming the overmolded layer. The overmolded layer 16 can, as previously noted, be formed of a low-viscosity material, like polyurethane or other material used to define at least part of a show surface or class-A exterior surface of the finished component.

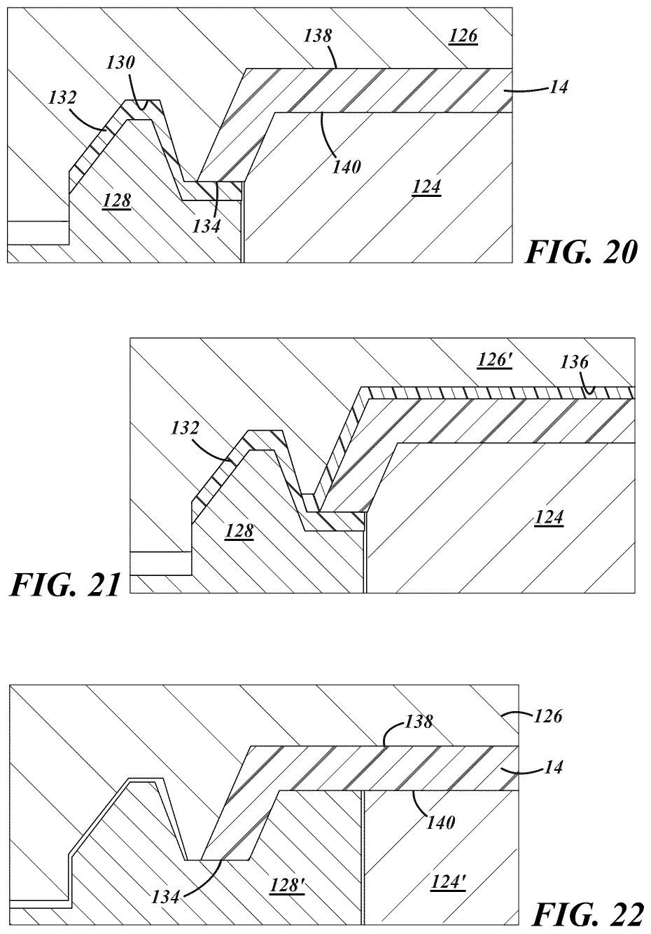

In the example shown in FIG. 19, the mold system 120 includes a first mold cavity 122 that is formed between a first mold part 124, a second mold part 126 and a third mold part 128 is in a first position in which the third mold part 128 engages the first mold part 124 at one boundary of the first mold cavity 122. After the substrate 14 is formed in the first mold cavity 122 during a first phase of the molding process, the third mold part 128 is moved to a second position, as shown in FIG. 20, in which a space is defined between the third mold part 128 and both the first mold part 124 and the substrate 14. This space is called herein a seal mold cavity 130 or a third mold cavity with the first mold cavity 122 being used to form the substrate 14, and a second or overmold cavity (described later) used to form the overmolded layer 16.

In the second position, the third mold part 128 may engage the second mold part 126 at a location spaced from the substrate 14, and the first mold part 124 at an outer boundary of the seal mold cavity 130. The seal mold cavity 130 is thus defined between the first mold part 124, second mold part 126, third mold part 128 and the portion of the substrate 14 exposed by the movement of the third mold part 128 to its second position. The material for the seal 132 is provided in the seal mold cavity 130 in a second phase of the molding process. In this example, the seal 132 is molded onto a peripheral edge 134 of the substrate 14 and extends outwardly from the peripheral edge 134 to define an edge or “gimp” seal around all or part of the substrate 14. The outwardly extending gimp seal can, for example, provide a seal between the substrate 14 and one or more adjacent components (as also described later with regard to FIGS. 39-41).

In a third phase of the molding process, the second mold part 126 is moved or modified to define an overmold cavity 136. In this example, as shown in FIG. 21, the modification involves substituting a different mold part 126′ for the second mold part 126 that was used to define the first and third mold cavities 122, 130. The overmold cavity 136 is defined between the modified second mold part 126′, the seal 132 and the substrate 14, along part of a surface of the substrate 14 extending inwardly from the peripheral edge 134 on which the seal 132 is attached. In this example, a portion of the second mold part 126′ engages and may clamp and seal against the seal 132 to define a boundary of the overmold cavity 136. The material for the overmolded layer 16 is provided into the overmold cavity 136 and the overmolded layer 16 is molded onto a portion of the substrate 14 and a portion of the seal 132.

In the example of FIGS. 19-21, the movable third mold part 128 defined only the portion of the first mold cavity 122 that corresponds to the peripheral edge 134 of the substrate 14. An outer surface 138 of the substrate 14 was defined by the second mold part 126, and an inner surface 140 of the substrate 14 was defined by the first mold part 124. In the example shown in FIG. 22, the third mold part 128′ defines portions of the first mold cavity 122′ that define both the peripheral edge 134 and a portion of the inner surface 140 of the substrate 14. The remainder of the inner surface 140 of the substrate 14 is defined by a first mold part 124′ and the outer surface is defined by the second mold part 126 which may be the same as in the mold system 120 of FIGS. 19-21.

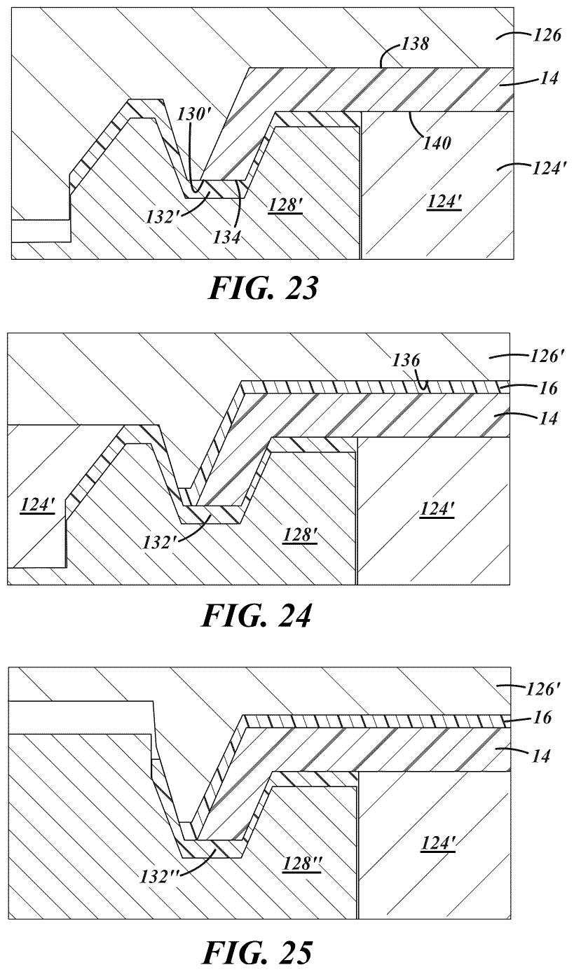

So arranged, when the third mold part 128′ is moved to its second position, a seal mold cavity 130′ is defined that overlaps both the peripheral edge 134 and the portion of the inner surface 140 of the substrate 14 that was defined by the third mold part 128′. In this example, the seal mold cavity 130′ also extends outwardly away from the edge 134 of the substrate 14, like that described above with regard to FIG. 20. Thus, as shown in FIG. 23, the seal 132′ is molded onto the edge 134 and part of the inner surface 140 of the substrate 14, and also extends outwardly beyond the edge 134 of the substrate 14 in the opposite direction.

Next, as shown in FIG. 24, in the third phase of the molding process, the overmold cavity 136 is formed by modification of the second mold part 126 in any desired way. In this example, the overmold cavity 136 and resulting overmolded layer 16 are the same as that described with regard to FIG. 21. FIG. 25 illustrates a mold system in which the seal 132″ extends outwardly a shorter distance than the seals 132 and 132′ shown in FIGS. 21 and 24, wherein those seals 132, 132′ include a generally U-shaped or V-shaped portion with two lips jointed together and arranged outwardly of the substrate 14. The seal 132″ shown in FIG. 25 includes a single lip and covers a portion of the inner surface 140 of the substrate 14 as in the example of FIGS. 23 and 24.

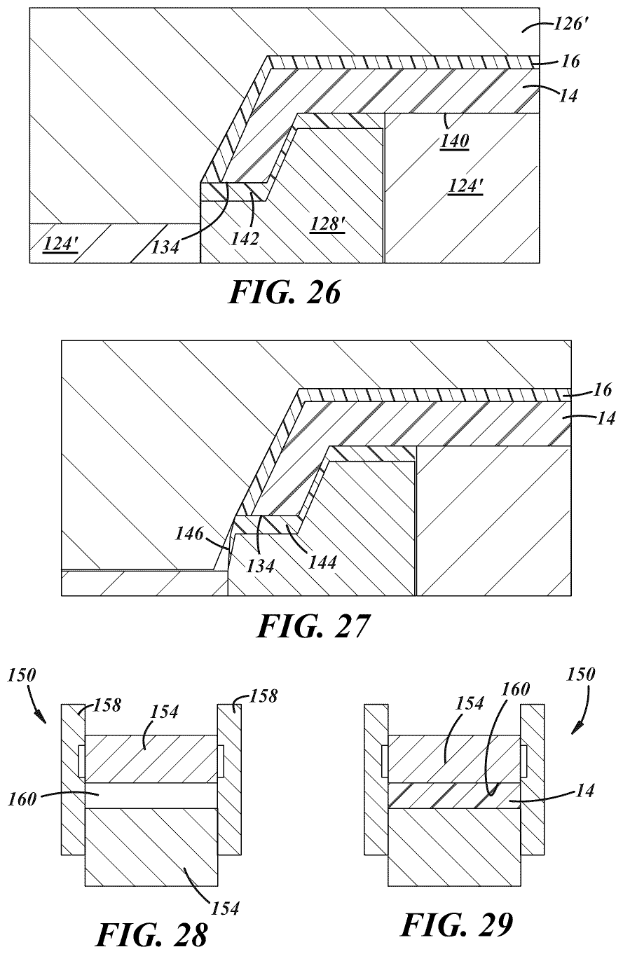

FIG. 26 illustrates mold parts that define a seal 142 that extends outwardly only a relatively short distance beyond the edge 134 of the substrate 14. The seal 142 in this example overlaps the edge 134 of the substrate 14 and a portion of the inner surface 140 of the substrate 14. The overmolded layer 16 is shown molded onto the outer surface 138 of the substrate 14, and overlapping and on the portion of the seal 142 that extends outwardly beyond the substrate edge 134. The overmolded layer 16 and seal 142 are shown to be flush outboard of the substrate 14, but need not be.

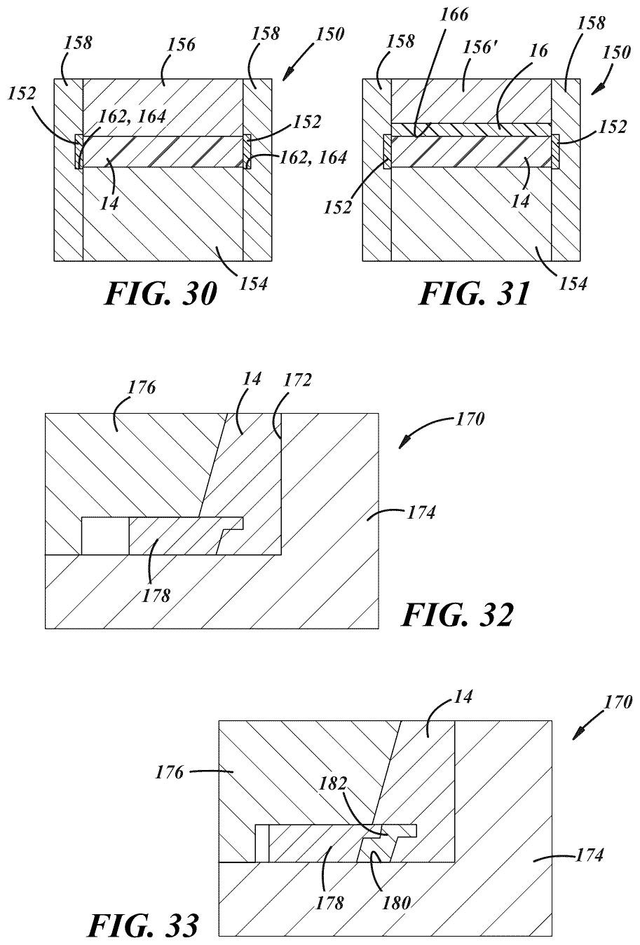

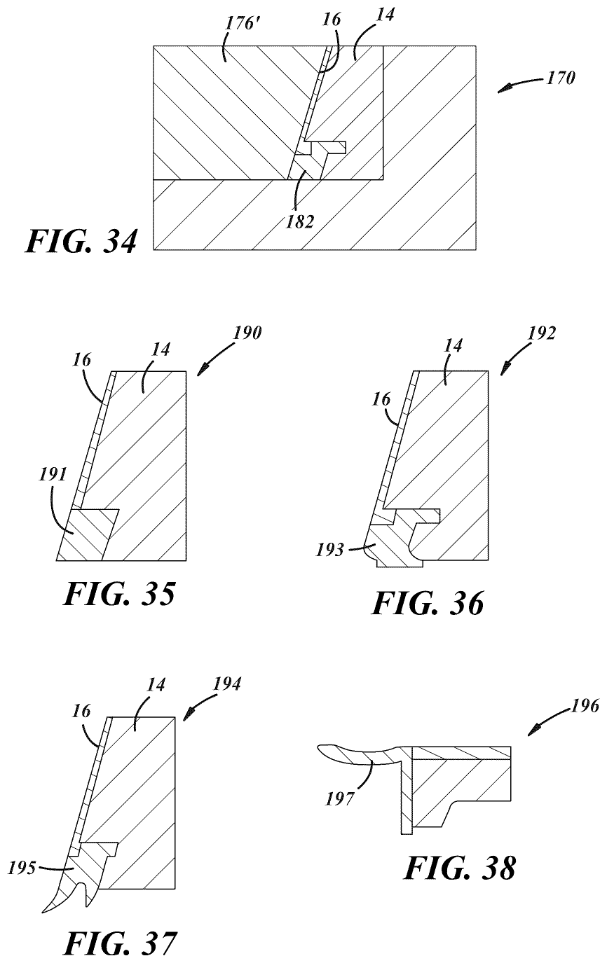

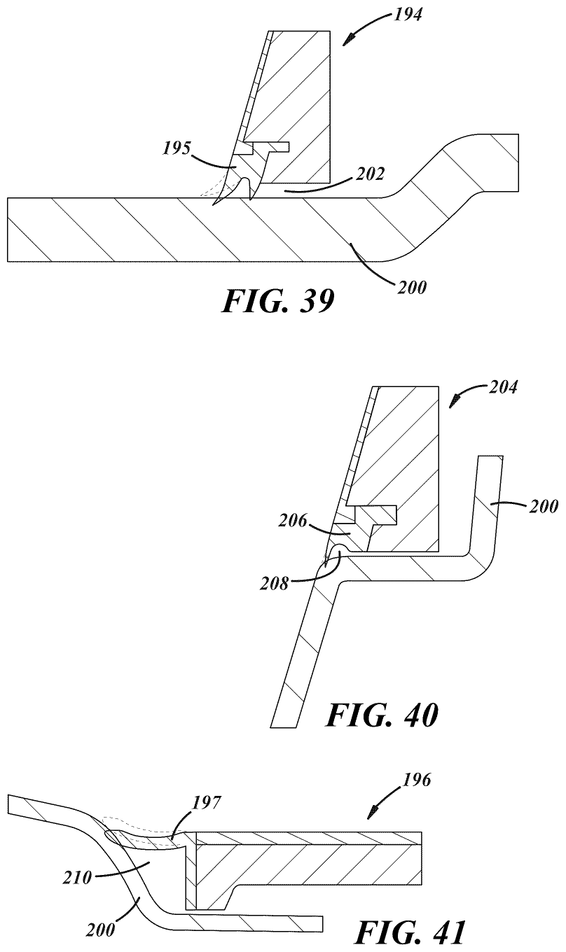

FIG. 27 illustrates mold parts that, like the seal 142 shown in FIG. 26, define a seal 144 that extends outwardly only a relatively short distance beyond the edge 134 of the substrate 14, and which extends inwardly (the direction from the outer surface toward the inner surface) beyond the portion of the seal 144 that overlaps and is molded to the peripheral edge 134 of the substrate 14. This portion of the seal 144 can provide a lip 146 that engages an adjacent surface when installed on the vehicle. The seal 144 in this example overlaps the edge 134 of the substrate 14 and a portion of the inner surface 140 of the substrate 14. The overmolded layer 16 is shown molded onto the outer surface 138 of the substrate, and overlapping and on the portion of the seal 144 that extends outwardly beyond the substrate edge 134.

FIGS. 28-31 shows a mold system 150 and process of forming a component having a substrate 14, an overmolded layer 16 and edge seals 152 (FIGS. 30 and 31) on opposite sides of a substrate 14. As shown in FIG. 28, the mold system 150 includes a first mold part 154, a second mold part 156 and a pair of movable third mold parts 158 arranged in a first position and at opposite sides of the first and second mold parts. The first mold cavity 160 is defined in part by each of the mold parts 154, 156, 158, and as shown in FIG. 29, in a first phase of a molding process using the mold system 150, the substrate 14 is molded within the first mold cavity 160. In a second phase of the molding process using the mold system 150, as shown in FIG. 30, the pair of third mold parts 158 are moved to a second position in which cavities 162 (e.g. one in each third mold part) are aligned with opposite sides of the substrate 14. The cavities 162 define part of the third mold cavities 164 in which the edge seals 152 are molded onto the substrate 14. The third mold cavities 164 are also defined in part by the substrate 14 and may also be partially defined by one or both of the first and second mold parts 154, 156. Finally, as shown in FIG. 31, in a third phase of the molding process using the mold system 150, the second mold part 156 is modified to define the overmold cavity 166 between the second mold part 156′, the substrate outer surface 138, and the edge seals 152. To finish the molding process, the material for the overmolded layer 16 is injected into the overmold cavity 166.

FIGS. 32-34 show a mold system 170 wherein the first mold cavity 172 (FIG. 32) is defined by a first mold part 174, second mold part 176 and movable third mold part 178. After the substrate 14 is formed, the third mold part 178 is moved to define, with the substrate 14 and first mold part 174, the third mold cavity 180 (FIG. 33) for the seal 182 that is molded onto the substrate 14. Finally, in FIG. 34, the second mold part 176′ is modified to define the overmold cavity 184 and the overmolded layer 16 is formed on the substrate 14 and on part of the seal 182.

FIG. 35-38 shows components 190, 192, 194, 196 that may be formed with a similar mold system as in FIGS. 32-34 including differently shaped mold parts to provide differently shaped overmolded layers 16 and seals 191, 193, 195 and 197, as desired. With movable mold parts used to form the seal, the seal may extend beyond the edges of the substrate and provide a depending lip or lips. FIG. 39 illustrates the component 194 shown in FIG. 37 installed next to an adjacent vehicle component 200, wherein the seal 195 engages the component 200 and provides a barrier against contaminants entering a gap 202 between the components 194, 200. FIGS. 40 and 41 illustrate, respectively, a component 204 and the component 196 shown in FIG. 38, wherein the seals 206, 197 bridge gaps 208, 210 between the components and another component 200. The elimination or reduction of a visible gap can provide an improved or cleaner appearance to the components, and may also help to limit contaminants from fouling the gap between the adjacent components.

In at least some implementations, the various mold systems provide improved sealing of a cavity in which an overmolded layer is formed on a substrate. Some materials used for the overmolded layer have low viscosity and are molded under pressure such that the material tends to flow along parting lines and form flash. The flash is later trimmed off which costs labor and time, and which can affect the surface finish and durability of the overmolded layer as the trimmed area is more susceptible to environmental damage. In some implementations, the overmolded layer defines part of all of an exterior, show surface or “class-A” exterior surface of a component, and so the surface finish and integrity of the overmolded layer can be important to the final product.

In some implementations, the improved sealing is provided by an overflow seal that is carried by or fixed to a mold part. The overflow seal is compressible against mold parts and/or the substrate to provide a seal against overflow our outflow of the material forming the overmolded layer. In this way, the boundary of the overmolded layer can be better controlled such that flash is not formed and subsequent trimming operations are not needed. The overflow seal can be provided on a fixed or movable mold part and selectively positioned and used to provide a seal when and where necessary. The seal material may have a hardness adapted to provide a desired compression of the seal while also maintaining structure integrity of the seal so that it can provide a desired finished shape to the adjacent area of the overmolded layer. Further, the seal material can be selected so that it can be molded into a desired shape, and to provide a desired sealing integrity and to avoid adhesion or bonding of the molded materials to the seal, with or without use of release agents. The overflow seal can be low cost and easy to service, clean or replace within a mold part when worn out or fouled. The seal can be in a fixed position on a mold part or on a movable mold part, and can be attached to an adjustable pneumatic or hydraulic slider to permit adjustment of the contact pressure in a way that there is enough seal off force for the process without pushing the substrate/molded article out of position within the mold cavity.

In some implementations, the improved sealing is provided by a seal that is itself overmolded onto the substrate prior to the molding of the overmolded layer. A wide variety of seal and overmolded layer configurations are possible, to achieve a wide range of functions for various different molded components. The seal not only functions to limit or prevent overmold material overflow and flash formation during product formation, but can also function as a seal or gap filler on the finished product.

In at least some implementations, a process for forming a component includes molding a substrate in a first mold cavity, providing an overmold cavity that is defined in part by the substrate, and molding an overmolded layer in the overmold cavity and onto the substrate. The overmold cavity is partly defined by an overflow seal that is carried by (e.g. attached to) a mold part and which seals off that part of the overmold cavity. The overflow seal abuts and seals against another mold part and part of the substrate, and provides a seal at a parting line between adjacent mold parts and the substrate. During molding of the overmolded layer, the seal may be clamped between mold parts and also between a mold part and the substate at spaced apart locations to provide multiple sealed areas to inhibit or prevent overflow of the overmold material.

In at least some implementations, a process for forming a component includes molding a substrate in a first mold cavity, providing a mold cavity for a seal where the seal mold cavity is defined in part by the substrate and molding a seal onto the substrate, and defining an overmold cavity that is defined in part by the substrate and the seal, and molding an overmolded layer in the overmold cavity and onto the substrate and seal. The seal molded to the substrate abuts and seals against multiple mold parts and part of the substrate, and provides a seal at a parting line between adjacent mold parts and the substrate.

In at least some implementations, a substrate is molded in a first mold cavity. Without opening the mold tools, another mold cavity is formed for a seal that is then molded onto the substrate. Thereafter, the molding tool can optionally be opened so that a different mold tool can be provided that defines part of an overmold cavity. Next, the molding tool is closed and the seal is clamped between the mold parts including the different mold tool and provides one or more seals to avoid leakage of the material of the overmolded layer when it is molded onto the substrate. Finally, the tool is opened and the formed component including the substrate, overmolded layer and the seal is removed from the mold.

The forms of the innovations herein disclosed constitute presently preferred embodiments and many other forms and embodiments are possible. It is not intended herein to mention all the possible equivalent forms or ramifications of the innovations. It is understood that the terms used herein are merely descriptive, rather than limiting, and that various changes may be made without departing from the spirit or scope of the present disclosure.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A method for forming an overmolded component, comprising:
arranging a first mold part and a second part with at least part of a first mold cavity defined by the first mold part and the second mold part;
providing material to form a substrate into the first mold cavity;
providing an overmold cavity that is defined at least in part by the substrate, one or both of the first mold part and second mold part, and a seal that engages the substrate and also engages one or both of the first mold part and the second mold part; and
providing material for an overmolded layer in the overmold cavity.

2. The method of claim 1 wherein the seal is carried by the first mold part and engages the second mold part and the substrate.

3. The method of claim 2 wherein the overmold cavity is defined by the substrate, the second mold part and the seal.

4. The method of claim 2 wherein the first mold part includes a cavity and the seal is located in the cavity.

5. The method of claim 1 which also includes providing a third mold part to define part of the overmold cavity, and wherein the seal is attached to the third mold part.

6. The method of claim 1 wherein the seal is compressed during formation of the overmolded layer.

7. The method of claim 5 wherein the seal is compressed during formation of the overmolded layer and the seal engages the second mold part and the substrate.

8. The method of claim 5 wherein the seal engages the first mold part, the second mold part and the substrate.

9. The method of claim 1 which also comprises providing a third mold part and wherein the seal is attached to the third mold part, and the seal defines part of the first mold cavity.

10. The method of claim 9 wherein the third mold part is movable from a first position in which the seal defines part of the first mold cavity to a second position in which the seal defines part of the overmold cavity.

11. The method of claim 1 which also includes providing a third mold part and a fourth mold part, wherein the method includes locating the third mold part so that the third mold part defines part of the first mold cavity, and after the material for the substrate is provided into the first mold cavity, moving the third mold part and providing a fourth mold part that includes the seal to define part of the overmold cavity.

12. The method of claim 5 wherein a portion of the third mold part spaced from the seal defines part of the first mold cavity such that the seal does not define part of the first mold cavity, and the method includes moving the third mold part from a first position in which the third mold part defines part of the first mold cavity to a second position in which the seal defines part of the overmold cavity.

13. A method of forming an overmolded component, comprising:
arranging a first mold part, a second part and a third mold part to define at least part of a first mold cavity;
providing material to form a substrate into the first mold cavity;
arranging the first mold part, the second mold part and the third mold part to define a seal mold cavity, where the seal cavity is defined in part by the substrate;
providing material for a seal in the seal mold cavity;
providing an overmold cavity that is defined at least in part by the seal and the substrate; and
providing material for an overmolded layer in the overmold cavity.

14. The method of claim 13 wherein the overmold cavity is partly defined by a fourth mold part that is different than the first mold part, the second mold part, and the third mold part.

15. The method of claim 13 wherein the third mold part is movable relative to the first mold part and the second mold part from a first position in which the third mold part defines part of the first mold cavity to a second position in which the third mold part defines part of the seal mold cavity.

16. The method of claim 15 wherein the seal mold cavity is defined by the first mold part, the second mold part, the third mold part and the substrate.

17. The method of claim 15 wherein the first mold part defines a portion of the first mold cavity that defines at least part of an inner surface of the substrate, the second mold part defines a portion of the first mold cavity that defines at least part of an outer surface of the substrate, and the third mold part defines part of the first mold cavity that defines at least part of a peripheral edge of the substrate between the inner surface and the outer surface.

18. The method of claim 17 wherein the seal mold cavity is defined in part by the peripheral edge of the substrate.

19. The method of claim 13 wherein the seal is compressed by one or more of the first mold part, the second mold part and the third mold part to close off part of the overmold cavity.

20. The method of claim 14 wherein the seal is compressed by the fourth mold part to close off part of the overmold cavity.
